(19) United States
(12) Patent Application Publication
(10) Pub. No.: US 2010/0049368 A1
(43) Pub. Date: Feb. 25, 2010

(54) ROBOT

(75) Inventor: GA-LANE CHEN, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/468,844

(22) Filed: May 19, 2009

(30) Foreign Application Priority Data
Aug. 21, 2008 (CN) 200810304127.7

(51) Int. Cl. B25J 19/04; B25J 19/02

(52) U.S. Cl. 700/259; 700/258; 901/47; 901/46; 901/1

(57) ABSTRACT

An exemplary robot includes an information collecting module, a controlling system and a driving module. The information collecting module comprises a voice identifying device, a detecting device and a motion sensing device. The information collecting module is configured for identifying identities of robot users, detecting distances between the robot and objects located therearound thereof and sensing motion states of the robot. The controlling system is configured for generating a controlling signal and sending the controlling signal to the driving module. The driving module is configured for receiving the controlling signal, and driving the robot to move and adjusting the movement of the robot based on the controlling signal.

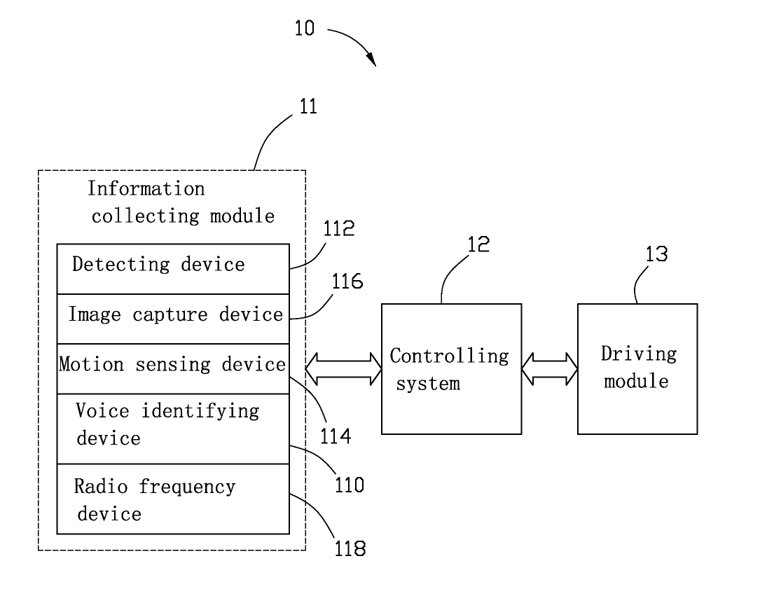

### BACKGROUND

1. Technical Field

The present invention generally relates to robots, and particular to a robot capable of being utilized in field of entertainment.

2. Discussion of Related Art

Nowadays, robots are used extensively in the field of industry. A general robot usually includes an instruction storing device, a controlling system and a driving device. The instruction storing device has predetermined operating instructions stored therein. The controlling system accesses the operating instructions stored in the instruction storing device and generating a controlling signal according to the operating instructions. The driving device receives the controlling signal and drives the robot to perform actions according to the controlling signal. However, such kind of robot is lacking in intelligence or liveliness, and therefore not applicable to be promoted in field of entertainment.

Therefore, what is needed is a robot, which method is capable of overcoming the above described shortcomings.

### BRIEF DESCRIPTION OF THE DRAWING

Many aspects of the present robot can be better understood with reference to the following drawing. The components in the drawing are not necessarily drawn to scale, the emphasis instead being placed upon clearly illustrating the principles of the present robot.

The drawing is a block diagram of a robot, according to an exemplary embodiment.

### DETAILED DESCRIPTION OF EMBODIMENTS

Reference will now be made to the drawings to describe embodiments of the present robot, in detail.

In the drawing, a robot 10, according to a first embodiment, is provided. The robot includes an information collecting module 11, a controlling system 12 and a driving module 13.

The information collecting module includes a voice identifying device 110, a detecting device 112 and a motion sensing device 114.

The voice identifying device 110 is configured for receiving voice produced by robot users, identifying identities of the users based on the voice, and converting the voice into operating instructions on the condition that the identities of the users is confirmed. When the users give voice commands to the robot, the voice identifying device 16 receives voice from the users and identifies identities of the robot users based on the voice. On the condition that the identities of the robot users is confirmed, the voice identifying device 16 transfers the voice (which embody the oral orders) into operating instructions and sends the operating instructions to the controlling system 12.

The detecting device 112 is configured for detecting distance between the robot and objects around the robot, generating a first feedback signal according to the detecting result and sending the first feedback signal to the controlling system 12. The detecting device 112 can be an infrared sensor capable of radiating infrared light. When the infrared light reaches the surrounding objects, the infrared light landed on the objects will be reflected back to the robot and subsequently be received by the detecting device 10. As such, the surrounding objects are detected. Further, distances between the robot and the surrounding objects can also be detected based on the transmission time of the infrared. The detecting device 112 can also be an ultra wave sensor, a sonar or a surface acoustic wave sensor. When the objects around the robot and distance between the objects and the robot are detected, a first feedback signal according to the detecting result will be generated by the detecting device 112 and sent to the controlling system 12.

The motion sensing device 114 is configured for sensing motion states of the robot, generating a second feedback signal according to the sensing result and sending the second feedback signal to the controlling system 12. The motion sensing device 14 includes an accelerometer, a gyroscope and a magneto-resistance sensor. The accelerometer is configured for sensing linear motion of the robot. The gyroscope is configured for sensing rotary angle of the robot. The magneto-resistance sensor is configured for sensing location of the robot.

The controlling system 12 is configured for receiving the operating instruction, the first and second feedback signals; generating a controlling signal according to the operating instruction, the first and second feedback signals; and sending the controlling signal to the driving module 13.

The driving module 13 is configured for receiving the controlling signal and driving the robot to move and adjusting the movement of the robot based on the controlling signal. The driving module 13 includes an actuating device for actuating the robot to move, for example running, walking, picking something up or/and placing something down, etc. The actuating device can be a piezoelectric actuator or an air cylinder.

The information collecting module 11 can further include an image capture device 116. The image capture device 116 is configured for capturing images of the objects around the robot and sending the images to the controlling system 12. The controlling system 12 is capable of identifying the objects around the robot based on the captured images and generating a corresponding controlling signal to the driving module 13. The image capture device 116 comprises a lens module for receiving and converging lights from the objects, and an image sensor for sensing the converged lights and forming images. The image sensor can be a charge-coupled device (CCD) sensor or a complementary metal oxide semiconductor (CMOS) sensor.

Still further, the information collecting module 11 can also include a radio frequency device 118 for receiving wireless signals from a remote controller and sending the wireless signals to controlling system 12. The controlling system 12 generates a controlling signal according to the wireless signals and sending the controlling signal to the driving module 13. Thereby, the driving module 13 drives the robot to move or act according to the wireless signals from the remote controller. The radio frequency device can be a wireless-fidelity (WIFI) communication device, a worldwide interoperability for microwave access (WiMAX) communication device, an ultra wide band (UWB) wireless sensing device, or a global positioning system (GPS).

Due to the robot being equipped with the voice identifying device 110, the robot can move and/or act according to voice commands stated by users, only on the condition that the identities of the user is confirmed. The detecting device 112 detects the objects around the robot and sends a first feedback signal to the controlling system 12. The motion sensing device 114 sensing motion states of the robot and sends a second feedback signal to the controlling system 12. The controlling system 12 generates a controlling signal according to the first and second feedback signals; and sending the controlling signal to the driving module 13. Thereby, the driving module 13 adjusts the movement of the robot based on the controlling signal. As such, the robot is intelligent and lively, therefore applicable to be promoted in field of entertainment.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A robot comprising
an information collecting module comprising
a voice identifying device configured for receiving voice from robot users, identifying identities of the users based on the voice, and converting the voice into operating instructions on the condition that the identities of the users is confirmed;
a detecting device configured for detecting distances between the robot and objects located therearound, generating a first feedback signal according to the detecting result; and
a motion sensing device configured for sensing motion states of the robot, and generating a second feedback signal according to the sensing result;
a controlling system configured for receiving the operating instruction, the first and second feedback signals, and generating a controlling signal according to the received operating instruction, the first and second feedback signals; and
a driving module configured for receiving the controlling signal and driving the robot to move and adjusting the movement of the robot based on the controlling signal.

2. The robot according to claim 1, wherein the detecting device is an infrared sensor, an ultra wave sensor, a sonar or a surface acoustic wave sensor.

3. The robot according to claim 1, wherein the motion sensing device comprises an accelerometer for sensing linear motion of the robot, a gyroscope, and a magneto-resistance sensor for sensing location of the robot.

4. The robot according to claim 1, wherein the information collecting module further includes an image capture device configured for capturing images of the objects around the robot and sending the images to the controlling system, the controlling system being configured for identifying the objects around the robot based on the images.

5. The robot according to claim 4, wherein the image capture device comprises a lens module from receiving and converging lights from the objects, and an image sensor for sensing the converged lights and forming images.

6. The robot according to claim 5, wherein the image sensor is a charge-coupled device sensor or a complementary metal oxide semiconductor sensor.

7. The robot according to claim 1, wherein the information collecting module further comprises a radio frequency device for receiving wireless signals from a remote controller and sending the wireless signals to the controlling system, the controlling system configured for generating a controlling signal according to the wireless signals and sending the controlling signal to the driving module.

8. The robot according to claim 7, wherein the radio frequency device is a wireless-fidelity communication device, a worldwide interoperability for microwave access communication device, an ultra wide band wireless sensing device, or a global positioning system.

9. The robot according to claim 1, wherein the driving module comprises an actuating device for actuating the robot to move.

10. The robot according to claim 9, wherein the actuating device is a piezoelectric actuator or an air cylinder.
